(19) United States
(12) Patent Application Publication
(10) Pub. No.: US 2016/0056436 A1
(43) Pub. Date: Feb. 25, 2016

(54) NEGATIVE ELECTRODE FOR LITHIUM-ION SECONDARY BATTERY, LITHIUM-ION SECONDARY BATTERY, AND METHOD FOR MANUFACTURING SAID NEGATIVE ELECTRODE AND LITHIUM-ION SECONDARY BATTERY

(71) Applicant: HITACHI, LTD.), Tokyo (JP)

(72) Inventors: Hiroshi HARUNA, Tokyo (JP); Makoto MIZUTANI, Tokyo (JP); Toshio ABE, Tokyo (JP)

(73) Assignee: HITACHI, LTD., Tokyo (JP)

(21) Appl. No.: 14/780,397

(22) PCT Filed: Apr. 3, 2013
(86) PCT No.: PCT/JP2013/060145

§ 371 Date: Sep. 25, 2015

(51) Int. Cl. H01M 2/16; H01M 10/0525; H01M 4/04; H01M 2/14

(52) U.S. Cl. CPC H01M 2/1673; H01M 2/145; H01M 10/0525; H01M 4/0404

(57) ABSTRACT

A lithium ion secondary battery includes a negative electrode primarily containing carbon as an active material, the negative electrode including a negative electrode active material and a coating material formed on the surface of the negative electrode active material, and the coating material is composed of a compound including boron and an alkyl group, and adsorbed on the surface of the negative electrode active material surface.

### TECHNICAL FIELD

The present invention relates to a negative electrode for a lithium ion secondary battery, a lithium ion secondary battery, and a method for manufacturing the negative electrode and the lithium ion secondary battery.

### BACKGROUND ART

For power sources for mobile communications such as cellular phones and portable personal computers in recent years, the reduction in size and the increase in energy density have been increasingly demanded, and not only the storage of power during the night, but also power sources for power storage in combination with solar cells or wind power generation have been progressively developed. In addition, hybrid cars and hybrid trains which use electric cars or electric power partially for power in view of environmental issues have been progressively put into practical use. Non-aqueous electrolyte secondary batteries decrease in charge-discharge efficiency through repeated charge and discharge, and lithium secondary batteries have been thus required which are less likely to cause time degradation in battery performance.

JP 2003-151539 A (PTL 1) discloses forming a coating film derived from boron by boric acid treatment of a negative electrode active material, and improving high-temperature storage characteristics of a battery by the formation of a coating film having a B—O bond and a coating film containing lithium on a negative electrode.

JP 2010-192430 A (PTL 2) discloses improving cycle characteristics of a battery through the addition of an additive containing boron to an electrolyte solution.

### CITATION LIST

### Patent Literatures

PTL 1: JP 2003-151539 A

PTL 2: JP 2010-192430 A

### SUMMARY

### Technical Problem

In the method in PTL 1, the electrode is subjected to treatment with a boric acid solution to form a coating film containing a compound having a B—O bond, and the compound having a B—O bond thus remains on the surface of the negative electrode. The compound having a B—O bond has the possibility of being dissolved in an electrolyte solution, thereby lowering the properties of a positive electrode and the electrolyte solution itself, and causing degradation of battery characteristics such as increased internal resistance of the battery.

In the method described in PTL 2, the boron-containing additive is used for the electrolyte solution, and the decomposition of the additives thus consumes charges, thus possibly causing the initial capacity of the battery to be decreased. Moreover, the increase in capacity for batteries in recent years results in insufficient suppression of time degradation.

### Solution to Problem

A lithium ion secondary battery includes a negative electrode mainly containing carbon as an active material, characterized in that the negative electrode includes a negative electrode active material and a coating material formed on the surface of the negative electrode active material, and the coating material is composed of a compound including boron and an alkyl group, and adsorbed on the surface of the negative electrode active material surface.

It is preferable to use, as a coating material, in particular, a boric acid ester compound such as the following compound (1).

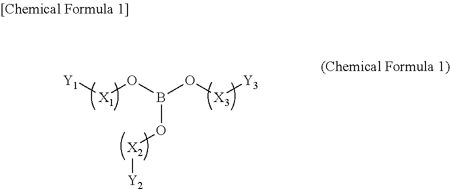

X represents a hydrocarbon group. Y represents hydrogen or a methyl group. The hydrocarbon group may be partially substituted with oxygen, sulfur, nitrogen, or a halogen, and X1, X2, X3, Y1, Y2, and Y3 may be different from each other. X preferably has from 1 to 10 carbon atoms.

The configuration mentioned above is able to improve the lifetime characteristics of the battery.

### BRIEF DESCRIPTION OF DRAWINGS

FIG. 1 is a schematic diagram representing the internal structure of a battery.

### DESCRIPTION OF EMBODIMENTS

As described above, the cases have been reported in which the lifetime is improved by producing an electrode surface coating film (solid electrolyte interphase: SEI) with the use of the boron compound as an additive for the electrolyte solution. However, mixing the additive in the electrolyte solution also produces disadvantages.

Because the SEI is formed on the negative electrode layer, it can be confirmed that storage characteristics of the battery are improved to suppress the rise in battery resistance, in the case of adding the boron compound to the electrolyte solution. However, while a boron-containing compound is produced on the negative electrode in an initialized charge-discharge test, the decomposition of the additive consumes charges, thereby causing a decrease in initial efficiency due to an irreversible reaction. Moreover, an excessive amount of boron compound is required to be added, and the boron compound remaining in the electrolyte solution, which is deposited through long-term usage, can cause an increase in electrode resistance, etc.

In order to control the initial charging reaction and the negative electrode interface production (SEI) growing with time, studies have been carried out while aiming to achieve a similar effect by providing a coating similar to the SEI in advance on a negative electrode. As a result, the boron compound physically adsorbed on the negative electrode surface is supposed to produce a similar effect to that of the SEI coating film, and prevent battery deterioration.

Thus, the present configuration is intended to provide a coating with the use of a compound that is physically adsorbable on the surface of a negative electrode active material, thereby producing an effect similar to that of the SEI, and improving the lifetime of a battery. Specifically, a boron-containing compound having an alkyl group, in particular, a boron compound having an alkyl group is physically adsorbed on the surface of a negative electrode active material, in particular, a carbon material such as graphite. The carbon material coated with the boron compound having an alkyl group makes it possible to prevent battery deterioration. In addition, it is also advantageous to be able to reduce the additive for an electrolyte solution. In particular, it is preferable to use a boric acid ester having an alkyl group.

As described above, a long-lifetime lithium secondary battery which is less likely to undergo aging deterioration can be provided by suppressing deterioration of a negative electrode such as graphite, and thus providing a longer lifetime. Furthermore, as a result of suppressing deterioration of the lithium secondary battery, and thus improving the initial performance, it is possible to reduce the amount of material used, thereby making it possible to provide a lithium secondary battery at low cost.

Embodiments will be described below with reference to the drawing, etc. The following description is intended to provide specific examples and the present configuration is not to be considered limited to the description of the examples, but various changes and modifications can be made by one skilled in the art within the scope of the technical idea disclosed in this description. In addition, through all the drawings parts that have the same functions are denoted by the same reference symbols, and the repeated explanations may be left out.

A lithium ion secondary battery according to an embodiment can be manufactured by, for example, disposing a negative electrode and a positive electrode as follows opposed with a separator interposed therebetween and injecting an electrolyte. The structure of a lithium ion battery according to an embodiment is not particularly limited, but typically, a positive electrode and a negative electrode, as well as a separator that separates the electrodes can be rolled to a rolled electrode group, or positive electrodes, negative electrodes, and separators are stacked to provide a stacked electrode group.

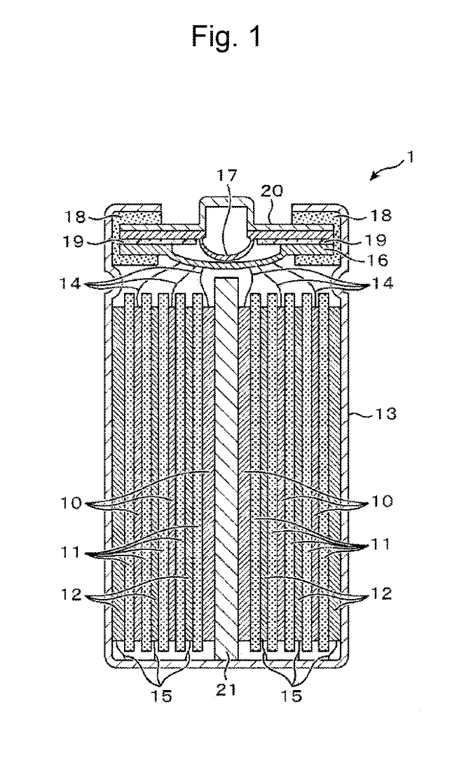

FIG. 1 is a diagram schematically representing the internal structure of a battery according to an embodiment. A battery 1 according to an embodiment as shown in FIG. 1 is composed of a positive electrode 10, a separator 11, a negative electrode 12, a battery can 13, a positive electrode collector tab 14, a negative electrode collector tab 15, an inner lid 16, an inner pressure release valve 17, a gasket 18, a resistor element of positive temperature coefficient (Positive temperature coefficient; PTC) 19, and a battery lid 20, and a shaft core 21. The battery lid 20 is a combined component composed of the inner lid 16, the inner pressure release valve 17, the gasket 18, and the resistor element 19. In addition, the positive electrode 10, the separator 11, and the negative electrode 12 are rolled around the shaft core 21.

The separator 11 is inserted between the positive electrode 10 and the negative electrode 12, and rolled around the shaft core 21 to prepare an electrode group. For the shaft core 21, any known shaft core can be used as long as the shaft core can support the positive electrode 10, the separator 11 and the negative electrode 12. The electrode group can have various shapes, such as strip electrodes stacked, or the positive electrode 10 and negative electrode 12 rolled into any shape, e.g., a flattened shape, or a multilayer structure by sequentially stacking the positive electrode 10 and negative electrode 12 housed in a bag-shaped separator that is used for the separator 11, in addition to the cylindrical shape shown in FIG. 1. For the shape of the battery can 13, a cylindrical shape, an oblate oval shape, a flattened ellipse shape, a rectangular shape, etc. may be selected to match the shape of the electrode group.

The material of the battery can 13 is selected from materials that are corrosion-resistant to non-aqueous electrolytes, such as aluminum, stainless steel, and nickel-plated steel. In addition, in the case of electrically connecting the battery can 13 to the positive electrode 10 or the negative electrode 12, the material of the battery can 13 is selected so as to keep corrosion of the battery can 13 or alteration of the material due to alloying with lithium ions from being caused at the site in contact with a non-aqueous electrolyte. Stainless steel is less likely to be corroded because a passivation film is formed on the surface, and the steel is thus high in strength, and capable of withstanding the increased inner pressure of a gas through the vaporization of the electrolyte solution, etc. in the battery can 13. Aluminum has a feature of high energy density per weight, because of its lightness.

The electrode group is housed in the battery can 13, and the negative electrode collector tab 15 is connected to the inner wall of the battery can 13, whereas the positive electrode collector tab is connected to the bottom of the battery lid 20. Before hermetically sealing the battery, the electrolyte solution is injected into the battery can 13. Methods for injecting the electrolyte solution include a method of adding directly to the electrode group with the battery lid 20 released, or a method of adding from an inlet created in the battery lid 20. On the positive electrode 10 and negative electrode 12, respectively, the positive electrode collector tab 14 and negative electrode collector tab 15 for current extraction are formed by spot welding or ultrasonic welding. The positive electrode collector tab 14 and the negative electrode collector tab 15 are each made from metal foil of the same material as the positive electrode collector or negative electrode collector in a rectangular shape, which are members placed for extracting electric currents from the positive electrode 10 and the negative electrode 12. This can be also applied to lithium secondary batteries for moving vehicles such as cars, these batteries are required to cause large electric currents to flow, and thus, in the case of applying the batteries to lithium secondary batteries for moving vehicles such as cars, a plurality of conduction tabs may be provided, if necessary.

Thereafter, the battery lid 20 is attached to the battery can 13, and the whole battery is hermetically sealed. When there is any inlet for the electrolyte solution, the inlet is also hermetically sealed. Methods for hermetically sealing the battery include known techniques such as welding and swaging. Further, the battery lid 20 is provided with a relief valve opened to relieve the pressure in the battery when the pressure in the battery is increased.

### <Negative Electrode>

In a negative electrode material according to an embodiment, a boric acid ester containing boron is physically adsorbed on carbon or the like that is a negative electrode active material to make it possible to inhibit the reaction between a surface functional group present on the surface of the negative electrode active material and the electrolyte solution, and suppress time deterioration of the battery.

Examples of the negative electrode active material include graphitizable materials obtained from natural graphite, petroleum coke, coal pitch coke, and the like, which are treated at a high temperature of 2500° C. or higher; mesophase carbon, or amorphous carbon and graphite that has surfaces coated with amorphous carbon; carbon materials of natural or artificial graphite with surfaces lowered in crystallinity by mechanical treatment; materials including an alkyl having a silane group on the surfaces through silicon treatment; materials with carbon surfaces coated with organic matters such as polymers or with the matters adsorbed on the carbon surfaces; materials of carbon fibers, lithium metals, silicon oxides, and silicon oxides with surfaces coated with carbon; and materials of metals alloyed with lithium and metals supported on the surfaces of carbon particles. For example a metal selected from lithium, aluminum, tin, silicon, indium, gallium, and magnesium, or an alloy is used as the metal for use in the negative electrode. In addition, the metals or oxides of the metals can be also used as the negative electrode active material. One of these compounds can be used alone, or two or more thereof can be used in mixture as the negative electrode substance.

Boric acid esters having B—O bonds adsorb on the surface of the negative electrode active material. The boric acid esters are represented by the following chemical formula (1).

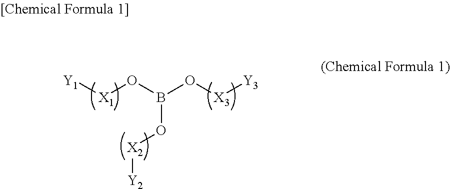

X represents a hydrocarbon group having one or more carbon atoms, which may be partially substituted with oxygen, sulfur, nitrogen, or a halogen. Y represents hydrogen or a methyl group. X1, X2, X3, Y1, Y2, and Y3 may be different from each other. X preferably has from 1 to 10 carbon atoms.

The boron located in the center of the boric acid ester represented by the chemical formula (1) is trivalent with an unshared electron pair, and thus slightly negatively charged. As a result, when the ester adsorbs on the surface of the negative electrode, the boron electrostatically interacts with an anionic site of a lithium salt that is used for the electrolyte, and it is thus believed that a contribution is made to an effective improvement in lithium ion transport number to suppress a rise in resistance. In addition, the effect of improving the lithium ion transport number can be also expected as lithium ions interact with the oxygen atoms next to the boron.

Furthermore, having an alkyl group increases the adsorption capacity onto the carbon surface, and inhibits a reaction with the electrolyte solution over time. As a result, battery deterioration over time, that is, arise in resistance is believed to be suppressed.

It is possible to prepare the negative electrode by applying the negative electrode active material mixed with a binder, etc. as an electrode combination to a current collector. In a method for producing the negative electrode 12, the active material and a boric acid ester are mixed with the binder, and the mixture is applied and pressed to provide an electrode. The thickness of the negative electrode combination layer is desirably adjusted to 50 to 200 μm. In the case of using a negative electrode collector, it is desirable to use copper foil of 7 to 20 μm in thickness.

In another method for producing the negative electrode 12, the negative electrode active material and a boric acid ester are mixed in water or an organic solvent, the solvent is removed to form a coating film, thereafter, the film is mixed with the binder, and the mixture is applied, pressed, etc. to provide an electrode. In the case of dispersing the boric acid ester represented by the chemical formula (1) in water, the condition of the slurry is observed carefully, and when the slurry turns into a gel, a surfactant is added, the pH value of the solution is adjusted, or the stirring rate, stirring temperature, etc. are changed depending on the materials.

Carboxymethyl cellulose, styrene-butadiene copolymers, etc. can be used for the dispersing material and the binder, and desirably account for a proportion on the order of 3 to 6 mass % in the negative electrode combination layer. The increased binder component leads to an increase in internal resistance value or a decrease in battery capacity. Alternatively, the excessively reduced binder component has the possibility of making it difficult to prepare electrode peeling, or causing the storage or cycle life of the battery to be lowered.

### <Positive Electrode>

The positive electrode 10 according to the present example is composed of a positive electrode active material, a conductive agent, a binder, and a positive electrode collector. In the case of using a carbon material as the negative electrode active material, layered compounds such as a lithium cobalt oxide (LiCoO₂) and a lithium nickel oxide (LiNiO₂), or one or more thereof substituted with a transition metal; or a mixture containing a lithium manganese oxide Li₁₊ₓMn₂₋ₓO₄ (where x=0 to 0.33), Li₁₊ₓMn_{2-x-y}M_{y}O₄ (where M contains at least one metal selected from Ni, Co, Fe, Cu, Al, and Mg, x=0 to 0.33, y=0 to 1.0, 2−x−y>0), LiMnO₄, LiMn₂O₄, LiMnO₂, LiMn₂₋ₓMₓO₄ (where M contains at least one metal selected from Ni, Co, Fe, Cu, Al, and Mg, x=0.01 to 0.1), or Li₂Mn₃MO₈ (where M contains at least one metal selected from Ni, Co, Fe, Cu, Al, and Mg), a copper-Li oxide (LiCuO₂), a disulfide compound, Fe₂(MoO₄)₃, or the like; or one of polyaniline, polypyrrole, and polythiophene, or a mixture of two or more thereof can be used as a positive electrode active material that reversely stores and releases lithium as a counter electrode.

In a method for producing the positive electrode 10, the positive electrode active material is mixed with the conductive material and the binder to provide slurry, and the slurry is mixed and kneaded sufficiently with the use of a mixer provided with a stirring means such as a rotary vane so that powder particles of the positive electrode active material are dispersed homogeneously. The sufficiently mixed slurry is applied onto both sides of a positive electrode collector of aluminum foil of 15 to 25 μm in thickness, for example, a roll-transfer applicator or the like. After the application to the both sides, press drying is carried out. The positive electrode combination layers applied onto the positive electrode collector are desirably adjusted to 50 to 250 μm in thickness. Examples of the conductive material include carbon material powders, and examples of the binder include polyvinylidene fluoride (PVDF). The mixture ratio of the conductive agent is preferably 5 to 20 mass %.

### <Electrolyte>

Examples of the non-aqueous solvent for use in the electrolyte solution include ethylene carbonate, propylene carbonate, gamma butyrolactone, dimethyl carbonate, ethyl methyl carbonate, and diethyl carbonate, which may be substituted with a halide such as a fluorine substitution or a sulfur element, and the solvents may be used alone, or two or more thereof may be used in mixture. In the case of using two more types of solvents, it is preferable to use a mixed solvent system of a high-viscosity solvent such as a cyclic carbonate or a cyclic lactone, and a low-viscosity solvent such as a chain carbonate or chain ester.

As the lithium salt, lithium salts can be used such as LiPF₆, LiBF₄, LiClO₄, LiAsF₆, LiCH₃SO₂, Li(CF₃SO₂)₂N, Li(C₂F₅SO₂)N, lithium bis(oxalato)borate, and lithium mono(oxalato)difluoride. These lithium salts may be used alone, or two or more thereof can be used in mixture.

The combination ratio of the solvents and the type and concentration of the electrolyte are determined based on test results for the initial and storage/cycle lives of the battery. In particular, as the electrolyte solution, it is desirable to use LiPF₆ or LiBF₄ dissolved as an electrolyte in a solvent of a cyclic carbonate such as ethylene carbonate, propylene carbonate, or gamma butyrolactone, and a chain carbonate solvent such as dimethyl carbonate and ethyl methyl carbonate, and use the electrolyte concentration between 0.6 to 2.0 mol/L.

As additives for improving characteristics of the battery, one or more types of compounds other than the main solvent and the electrolyte can be mixed in the electrolyte solution. As a specific example, vinylene carbonate or a compound having a carboxylic acid anhydride group, a compound including a sulfur element such as propane sultone, or a compound including boron is mixed in the electrolyte solution as a third component other than the solvent and the electrolyte. The compounds are selected for any purpose, because effects are expected such as inhibition of reductive decomposition at the surface of the negative electrode active material, inhibition of Mn elution from the positive electrode active material, improvement in ion conductivity in the electrolyte solution, and enhanced non-flammability or flame retardancy of the electrolyte solution. The compounds include a coating agent that forms a coating film on the surface of the negative electrode or positive electrode active material, such as vinylene carbonate and propane sultone; an overcharge suppression additive such as cyclohexylbenzene; an additive that imparts flame retardancy with phosphazenes, phosphoric acid series, boric acid systems, halogen substitution; an self-digestion additive; and an additive that improves electrode/separator wettability.

### <Separator>

For the purpose of preventing a short circuit due to the positive electrode 10 and negative electrode 12 in direct contact with each other, the separator 11 is used. For the separator 11, microporous polymer films such as polyethylene, polypropylene, and aramid resins can be used which may have surfaces coated with heat-resistant substances such as alumina particles.

### EXAMPLES

The present configuration will be further described below by providing specific examples and a comparative example.

### Example 1

### Preparation of Positive Electrode

Li_{1.02}Mn_{1.98}Al_{0.02}O₄ of 10 μm in average particle size and 1.5 m²/g in specific surface area was used for the positive electrode active material. A mixture of massive graphite and acetylene black at 9:2 in 85 wt % of the positive electrode active material was regarded as the conductive agent, and dispersed in an NMP solution adjusted in advance to 5 wt % of PVDF as the binder. The mixture proportions of the positive electrode active material, conductive agent, and PVDF were adjusted to 85:10:5 in terms of proportion by weight.

This slurry was applied to aluminum foil (positive electrode collector) of 20 μm in thickness homogeneously and uniformly as much as possible. After the application, drying was carried out at a temperature of 80° C., and in accordance with the same procedure, the slurry was applied to both sides of the aluminum foil, and dried. Thereafter, the foil with the slurry applied thereon was subjected to compression molding with a roll press, and cut to be 5.4 cm in application width and 50 cm in application length, and a leading piece of aluminum foil for extracting electric current was welded to prepare the positive electrode 10.

### (Preparation of Negative Electrode)

Natural graphite of 0.368 nm in the spacing obtained by X-ray diffraction measurement, 20 μm in average particle size, and 5 m²/g in specific surface area was used for the negative electrode active material. Trimethyl borate was dissolved at a concentration of 10% in distilled water. Then, the aqueous solution of trimethyl borate and natural graphite were stirred such that the concentration of the trimethyl borate with respect to the active material weight is 1 wt %, and then dried in a thermostatic bath at 80° C. to obtain a negative electrode active material including boron and an alkyl group. The measurement of the obtained negative electrode material by X-ray photoelectron spectroscopy has succeeded in confirming a peak derived from boron at 192 to 193 eV, and confirmed boron contained. In addition, the thus prepared natural graphite has a specific surface area decreased to 4 m²/g.

The negative electrode and an aqueous dispersion of carboxymethyl cellulose were mixed sufficiently, and an aqueous dispersion of a styrene-butadiene copolymer was dispersed in the mixture to provide negative electrode slurry. The mixture proportions of the negative electrode material, carboxymethyl cellulose, and styrene-butadiene were adjusted to 98:1:1 in terms of proportion by weight. This slurry was applied to rolled copper foil (negative electrode collector) of 10 μm in thickness in a substantially uniform manner. In accordance with the same procedure as for the positive electrode 10, the slurry was applied to both sides of the rolled copper foil, and dried. Thereafter, the foil with the slurry applied thereon was subjected to compression molding with a roll press, and cut to be 5.6 cm in application width and 54 cm in application length, and a leading piece of copper foil was welded to prepare the negative electrode 12.

### (Preparation of Battery)

The prepared positive electrode 10 and negative electrode 12 were used to prepare the cylindrical battery 1 as shown in FIG. 1. The positive electrode lead 7 and negative electrode lead 5 at tabs each for electric current extraction were formed by ultrasonic welding. The positive electrode lead 7 and negative electrode lead 5 at the tabs are composed of metal foil of the same materials respectively as the rectangular collectors, and members set for extracting electric currents from the electrodes. The separator 11 that is a single-layer film was sandwiched and stacked between the positive electrode 1 and negative electrode 2 with the tabs, rolled in a cylindrical form (spiral form) as an electrode group as shown in FIG. 1, and housed in the battery can 13 as a cylindrical container. After the electrode group was housed in the battery can 13, an electrolyte solution was injected into the battery can 13, and the can was hermetically sealed with a gasket.

For the electrolyte solution, LiPF₆ was dissolved as an electrolyte in a mixed solution of ethylene carbonate (EC) and ethyl methyl carbonate (EMC) mixed in proportions at EC:EMC=1:2 in terms of proportion by weight so that the concentration of LiPF₆ was 1.0 mol/L. Further, vinylene carbonate was mixed to be 1 wt % with respect to the weight of the mixed solution. The thus prepared electrolyte solution was injected into the battery can 13 through the gasket 18 of the battery lid 20 for hermetical seal with a positive electrode terminal attached thereto, and through hermetical seal by swaging, the cylindrical battery 1 of 18 mm in diameter and 650 mm in length was provided.

### (Performance Measurement)

The prepared cylindrical battery 1 was subjected to constant-current and constant-voltage charge for 5 hours at a charging current of 1500 mA and a voltage of 4.2 V, and as for discharge, subjected to constant-current discharge at a discharging current of 1500 mA up to a battery voltage of 3.0 V. This charge-discharge process was regarded as one cycle, and three cycles were implemented in total. The amount of voltage drop at 10 seconds after the start of discharge in the third cycle was figured out, and divided by the current value of 1500 mA to provide an initial resistance value. This battery was again discharged down to 3.0 V at 1500 mA, and subjected to constant-current and constant-voltage charge at a voltage of 4.2 V and a charging current of 1500 mA for 5 hours. This series of charge-discharge test was tested in a thermostatic bath at 25° C. After the end of the test at 25° C., was left for 60 days in a thermostatic bath at 50° C. in order to check the storage characteristics of the battery. After 60 days, the battery was taken out from the thermostatic bath at 50° C., and left for 1 day in a thermostatic bath at 25° C. After leaving the battery and removing heat, the battery was discharged at 1500 mA down to 3.0 V, discharged at 1500 mA down to 3.0 V, and subjected to constant-current and constant-voltage charge at a charging current of 1500 mA and a voltage of 4.2 V for 5 hours. Then, the battery was discharged at 1500 mA, and the amount of voltage drop after the start of the discharge was figured out, and divided by the current value of 1500 mA to provide a resistance value after the storage for 60 days.

As expressed by the following formula, the ratio between the initial resistance value and the resistance value after 60 days was obtained, and regarded as a rate of rise in resistance.

Rate of Rise in Resistance(%)=Resistance Value after 60 Days(Ω)/Initial Resistance Value(Ω)

### Examples 2 to 4, Comparative Example 1

With, in place of the trimethyl borate, an example of using triethyl borate, an example of using B(O—C₁₀H₂₁)₃, an example of using B(O—C₁₈H₃₇)₃, and an example of using, for the negative electrode active material, natural graphite subjected to no boron treatment, respectively referred to as Example 2, Example 3, Example 4, and Comparative Example 1, cylindrical batteries were prepared in the same way as in Example 1. Further, a performance test was carried out as is the case with Example 1.

TABLE 1

| | | | Difference |
|---|---|---|---|
| | | | from |
| | | Rate of Rise in | Comparative |
| | Treatment Material | Resistance (%) | Example (%) |
| Example 1 | B(O—CH3)3 | 123 | 17 |
| Example 2 | B(O—C2H5)3 | 124 | 16 |
| Example 3 | B(O—C10H21)3 | 128 | 12 |
| Example 4 | B(O—C18H37)3 | 135 | 5 |
| Comparative | No | 140 | — |
| Example 1 | | | |

The respective rates of rise in resistance were compared with the case of using the pure natural graphite subjected to no boron treatment (Comparative Example 1) as a reference. In Example 1, the storage characteristics have increased by 17%, thus succeeding in confirming the increased lifetime of the battery. The rise in resistance after the storage test for the lithium ion secondary battery can be suppressed to improve the lifetime characteristics of the battery.

It is believed that because of the formation of the coating film containing boron on the surface of the negative electrode active material, performance degradation due to the decomposition of the electrolyte solution at the interface of the negative electrode active material has been supposed to succeed in suppressing time degradation of the battery. In addition, the trivalent boron contained in the coating film containing boron has an unshared electron pair, electrostatically interacts with an anionic site of the lithium salt used for the electrolyte, and thus has the possibility of having made a contribution to an effective improvement in lithium ion transport number to suppress a rise in resistance.

As shown in Examples 2, 3, and 4, also when the boric acid ester group has an alkyl group made longer, the rise in resistance has been suppressed as compared with Comparative Example 1. However, when the alkyl is longer, the effect of improving the storage characteristics has been decreased. Therefore, the alkyl chain is preferably adapted to have 1 to 10 carbon atoms.

In the present examples, because of the same amount of boric acid ester mixed in terms of proportion by active material weight, it is believed that when the long-chain alkyl was subjected to polymerization, the number of boron atoms in a molecule of the boric acid ester was decreased to decrease the effect of improving the lithium ion transport number through electrostatic interaction with an anionic site of the lithium salt used for the electrolyte. However, in general, when the alkyl group is longer, it is expected that the adsorption effect onto the surfaces of carbon, etc. (a so-called effect such as a surfactant) will be made more likely to be produced to improve the degree of coating the carbon surface, and make the degradation inhibiting effect for the electrolyte solution more remarkable. It is believed that the effect of improving the transport number by boron and the surface-activating effect created by the long-chain alkyl group influence each other reciprocally to produce a resistance reduction effect as in the present invention.

### Example 5

The method for preparing the boron-coated natural graphite material was changed, and prepare a cylindrical battery in the same way as in Example 1.

Natural graphite of 0.368 nm in the spacing obtained by X-ray diffraction measurement, 20 μm in average particle size, and 5 m²/g in specific surface area was used for the negative electrode active material. The natural graphite was mixed sufficiently with an aqueous dispersion of carboxymethyl cellulose, and an aqueous solution of trimethyl borage was added thereto, and further mixed. Then, an aqueous dispersion of a styrene-butadiene copolymer was dispersed therein to prepare negative electrode slurry. The mixture proportions of the negative electrode material, carboxymethyl cellulose, and styrene-butadiene were adjusted to 98:1:1 in terms of proportion by weight. This slurry was applied to rolled copper foil (negative electrode collector) of 10 μm in thickness in a substantially uniform manner. In accordance with the same procedure as for the positive electrode 10, the slurry was applied to both sides of the rolled copper foil, and dried. Thereafter, the foil with the slurry applied thereon was subjected to compression molding with a roll press, and cut to be 5.6 cm in application width and 54 cm in application length, and a leading piece of copper foil was welded to prepare the negative electrode 12. The measurement of the thus prepared negative electrode material by X-ray photoelectron spectroscopy has succeeded in confirming a peak derived from boron at 192 to 193 eV, and confirmed boron contained. Then, in the same way as in Example 1, a cylindrical battery was prepared to measure battery characteristics.

### Examples 6 to 8

With, in place of the trimethyl borate, an example of using B(O—C₂H₅)₃, an example of using B(O—C₁₀H₂₁)₃, and an example of using B(O—C₁₈H₃₇)₃, respectively referred to as Example 6, Example 7, and Example 8, cylindrical batteries were prepared in the same way as in Example 5. Further, a performance test was carried out as is the case with Example 1.

TABLE 2

| | | | Difference |
|---|---|---|---|
| | | | from |
| | | Rate of Rise in | Comparative |
| | Treatment Material | Resistance (%) | Example (%) |
| Example 5 | B(O—CH3)3 | 123 | 17 |
| Example 6 | B(O—C2H5)3 | 123 | 17 |
| Example 7 | B(O—C10H21)3 | 125 | 15 |
| Example 8 | B(O—C18H37)3 | 134 | 8 |
| Comparative | No | 140 | — |
| Example 1 | | | |

As shown in Examples 5, 6, 7, and 8, as compared with Comparative Example 1, the rate of rise in resistance can be reduced even by the methods for preparing a negative electrode, which differ from the methods described in Examples 1, 2, 3, and 4. However, when the alkyl group is long, the method for preparing a negative electrode as described in Example 5 has achieve a greater effect on the improvement of storage characteristics. For example, when Example 3 is compared with Example 7, the effect is 3% greater in Example 7. When the alkyl is longer, the surface-activating effect is further produced, and it is believed that compatibility, etc. with the carboxymethyl cellulose or binder component for use in the preparation of the negative electrode has been affected to further enhance the coating effect.

As described above, holding the boron-containing compound having an alkyl group on the negative electrode has succeeded in significantly improving the storage characteristics of the battery. As a result, time degradation of the battery can be suppressed to improve the lifetime characteristics of the battery remarkably.

### REFERENCE SIGNS LIST

10 positive electrode
11 separator
12 negative electrode
13 battery can
14 positive electrode collector tab
15 negative electrode collector tab
16 inner lid
17 inner pressure release valve
18 gasket
19 PTC element
20 battery lid
21 shaft core

1. A negative electrode material for a lithium ion secondary battery, comprising:
a negative electrode active material; and
a coating material formed on a surface of the negative electrode active material,
wherein the coating material comprises a boron compound having an alkyl group, and
the boron compound is adsorbed on the negative electrode active material, and
the boron compound is a compound represented by the following formula (1): 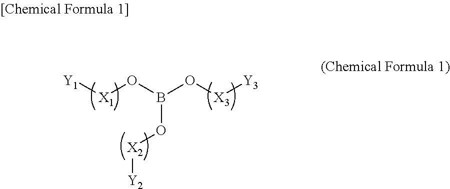
wherein X represents a hydrocarbon group; Y represents hydrogen or a methyl group; The hydrocarbon group may be partially substituted with oxygen, sulfur, nitrogen, or a halogen, and X1, X2, X3, Y1, Y2, and Y3 may be different from each other; and X has from 1 to 10 carbon atoms.

2. The negative electrode material for a lithium ion secondary battery according to claim 1,
wherein the boron compound is a boric acid ester compound.

3. (canceled)

4. The negative electrode material for a lithium ion secondary battery according to claim 1,
wherein the negative electrode active material comprises at least either one of amorphous carbon or graphite.

5. The negative electrode material for a lithium ion secondary battery according to claim 1,
wherein the negative electrode active material comprises a natural graphite.

6. A lithium ion secondary battery comprising a positive electrode and a negative electrode that store or release lithium ions, and an electrolyte solution,
wherein the negative electrode uses the negative electrode material according to any of claims 1 to 5.

7. A method for manufacturing a negative electrode for a lithium ion secondary battery, the method comprising the steps of:
attaching a boric acid ester compound to a surface of a carbon material;
mixing the carbon material with the boric acid ester compound attached, and a binder, thereby preparing a negative electrode combination; and
applying the negative electrode combination to a current collector; and
wherein the boric acid ester compound is a compound represented by the following formula (1): 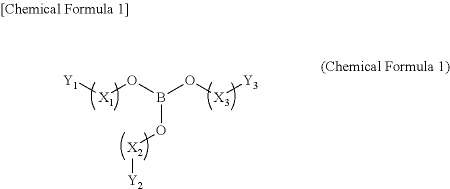
wherein X represents a hydrocarbon group; Y represents hydrogen or a methyl group; The hydrocarbon group may be partially substituted with oxygen, sulfur, nitrogen, or a halogen, and X1, X2, X3, Y1, Y2, and Y3 may be different from each other; and X has from 1 to 10 carbon atoms.

8. (canceled)
